(19) United States
(12) Patent Application Publication
(10) Pub. No.: US 2018/0017323 A1
(43) Pub. Date: Jan. 18, 2018

(54) HEAT EXCHANGER WITH THERMAL FLUID-CONTAINING SHAFT AND SHAFT-RIDING AUGER FOR SOLIDS AND SLURRIES

(71) Applicants: John Potee Whitney, Dallas, TX (US); Preston Ochas Whitney, Dallas, TX (US); Mark Wechsler, San Mateo, CA (US)

(72) Inventors: John Potee Whitney, Dallas, TX (US); Preston Ochas Whitney, Dallas, TX (US); Mark Wechsler, San Mateo, CA (US)

(21) Appl. No.: 15/209,060

(22) Filed: Jul. 13, 2016

(51) Int. Cl. F26B 3/04; F26B 21/02; F26B 21/00; F26B 25/06; F26B 15/12

(52) U.S. Cl. CPC F26B 3/04; F26B 25/06; F26B 15/12; F26B 21/005; F26B 21/02

(57) ABSTRACT

Serially connected heat exchange segments of a heat exchanger are stacked with ends of adjacent segments oriented oppositely. The segments have fixed pipes for heat exchange, pipe-riding shaftless auger flights for conveying feed material, and flanges for low-cost adjustment, removal and replacement of pipes and flights. Flights when arranged in arrays are arranged in pairs of counterrotating oppositely handed mutually cleaning flights. Rotary unions are unnecessary in this exchanger.

### TECHNICAL FIELD

This application claims the benefit of prior copending provisional application 62/192,000, filed 13 Jul. 2015, the entirety of which is incorporated herein by reference.

The present invention relates to an indirectly heated thermal processor, more particularly to a fluid-heated thermal processor equipped with an auger for conveying material, and especially to such with a shaft-riding auger.

The inventors were intrigued by various difficulties they perceived plaguing apparatus for the thermal processing of materials, as, for example, for the purpose of drying a material. One such perceived difficulty realtes to steam-heated dryers. Medium-to-low pressure steam often is used for drying a material, because it contains a large amount of heat energy and is widely available as a byproduct of industrial processes. However, the steam commonly available is often at a temperature not much higher than the approximately 100° C. required to evaporate water from common process materials. With a temperature differential of perhaps no more than 10-50° C., a steam-heated dryer requires a large surface area to drive the evaporation efficiently. If traditional technology is used, large surface area is achieved at a penalty in overall size and cost.

More generally, when continuous thermal processors are used for processing non-flowable materials such as solids, semi-solids and sludge, the feedstock must be conveyed through the processor on a first-in, first-out basis while being subjected to heat exchange. Commonly, this is done using paddle dryers and thermal screws, which are heated by hot organic fluids pumped through a thermal loop from a fluid heater to the heat exchanger or processor. As heat exchange surfaces, both screws and paddles are complex and expensive. Each screw must be connected to the supply and return of thermal fluid through a rotary union.

The available fluids for forced circulation allow a hot supply temperature up to 650° F. unpressurized with the highest heat-capacity synthetic fluids. Economical natural fluids are limited to 600° F. Up to 700° F. is possible at 75 PSI, and 750° F. at 150 PSI with more costly equipment. The typical difference in temperature between supply and return is approximately 60° F. The practical maximum mean temperature for the organic fluids operating at ambient pressure is less than 610° F. At practical pressures for thermal screws, the maximum mean temperature is 660° F. with a pressurized system. Under special conditions with 150 PSI equipment, the mean temperature of the heat transfer fluid can be increased to 710° F. with a forced circulation system.

When 150 PSI design is used with a thermal screw, the shape of the flight on the screw is limited when practical materials of construction are used. The necessary rotary unions are very costly for these temperatures and pressures. High temperature heating medium is very important because, even when the process only requires a little energy to be transferred at high temperature, for practical purposes, the maximum process discharge temperature is about 80° C. less than the supply temperature of the heating medium.

Organic vapors usable at pressures below 14 PSIG are available for temperatures from 470° F. to 570° F. At less than 75 PSI, the vapor temperature can be up to 695° F. At 150 PSI, the vapor temperature can be 745° F. Consequently, for practical purposes, the available vapor heating medium supply temperature is from 470° F. to 745° F., making possible vapor heated discharge temperatures up to 595° F.

For any particular feedstock and process, the capacity of the processor is also affected by the U factor, i.e., the overall heat transfer coefficient for a unit of area independent of the LMDT or temperature of the heating medium. This U is improved by increased mixing of the materials and significantly by preventing fouling of the heat exchange surfaces.

Present conventional solids heat exchangers are hollow flighted thermal screws or paddle dryers. These machines are formed of very complex shapes with very costly heat exchange surfaces. The heating medium is usually hot oil to allow a high LMDT without excessive vapor pressure. When steam or organic vapors are used, very complex internal structures are required to remove the condensate from the hollow flight thermal screws. The screws and paddles are arranged both to serve as heat exchange surfaces and to continuously convey the material through the process chamber. Very special arrangements are required, as described in the '639-patent, to prevent fouling of the heat exchange surfaces.

To accomplish controlled drying of solids in a continuous process, it is necessary to move the material through the heat exchanger on a first in/first out basis: Solids must be mechanically moved through the heat exchanger by some positive force. In the drying and heating of solids, the material frequently undergoes a partial or complete phase change, including a sticky phase in which the material does not move, but simply adheres to the surfaces that contain it. At such times, it is necessary to scrape the heat exchange surfaces in order to prevent the adherent material from fouling the surfaces so severely that the heat exchange capacity is unacceptably impaired.

In some cases it is also necessary to scrape a surface which is not a heat exchange surface, but is a surface of a mechanical device that conveys the material being treated through the apparatus. If such a surface is not scraped and the material being processed is, or becomes, a type that adheres to adjacent surfaces, the voids that should be open as passages for material to move through become blocked and the processor becomes plugged.

### SUMMARY OF THE INVENTION

The inventors wished to provide a heat exchanger-processor which boosts efficiency by optimizing residence time in each of a plurality of serially arranged transport segments and by self-cleaning during operation. Additionally, the inventors sought to provide such an exchanger-processor which would be inexpensive, lacking complex and costly rotary junctions, and which would be easily maintainable, its pipes being adjustable and its pipes and augers being replaceable without welding or other complicated and costly work.

In accordance with the present invention, an indirect heat exchanging continuous material processor has a housing portion having a feed material receiving end and a feed material delivering end. A steam plenum is disposed at the feed material delivering end of the housing portion. A pipe is disposed in the housing portion and has a flanged end supported at and fluidly communicating with and sealingly and removably attached to the steam plenum. The pipe also has a fluidly closed, post-equipped end opposite the flanged end. A transport is disposed at and removably attached to the feed material receiving end of the housing portion. An auger shaft is coupled to and rotationally driveable by the transport, projects into the housing portion proximate the pipe, rotatably engages the post-equipped end of the pipe, and supports the post-equipped end of the pipe. A helical flight is disposed in the housing and rides on the pipe. The helical flight has a proximal end rotationally coupled to and driveable by the auger shaft.

Also in accordance with the present invention, the flight is capable of removal and reinstallation without welding. Additionally, the pipe is capable of rotational adjustment relative to the steam plenum, removal from the steam plenum, and reinstallation in the steam plenum, without welding.

Also in accordance with the present invention, the steam plenum is capable of removal from and reinstallation onto the housing portion without welding.

Also in accordance with the present invention, the processor may have a plurality of the housing portions so equipped, the feed material receiving end of the second and subsequent of the plurality of housing portions receiving feed material from the feed material delivering end of the previous one of the plurality of housing portions. Respective transports of the plurality of housing portions being operable at independently controllable rates of rotation.

Also in accordance with the present invention, the housing portion may have a plurality of the pipes, auger shafts and helical flights so interrelated, the plurality of pipes, shafts and helical flights being arrayed such that any two helical flights which are mutually adjacent are also opposite-handed, the transport driving the plurality of auger shafts in a manner ensuring that any two auger shafts which are mutually adjacent are also counterrotating at a common speed.

Also in accordance with the present invention, plurality of such housing portions can be arranged, inlet-to-outlet, serially.

Also in accordance with the present invention, a purge tube may be disposed in the pipe and have a first opening within the pipe and a second opening configured for withdrawal of a fluid from the pipe.

Also in accordance with the present invention, a fluid circulation tube may be disposed in the pipe and have a first opening within the pipe and a second opening configured for supply of a fluid to the pipe via the fluid circulation tube.

In accordance with the present invention, a method of indirect heat exchanging continuous processing of a feed material includes the steps of providing a processor housing portion having a feed material inlet and a feed material outlet; introducing a feed material into the feed material inlet; contacting the feed material with a helical flight within the housing portion; supporting the helical flight proximate the feed material inlet and engaging the helical flight with a conveyor drive proximate the feed material inlet; supporting the helical flight on a pipe disposed within and roughly coaxial with the helical flight; supporting the pipe proximate the feed material outlet; supplying a heat exchange fluid to the pipe at a portion thereof proximate the feed material outlet and withdrawing the heat exchange fluid from the pipe proximate the feed material outlet; operatively coupling the pipe to the conveyor drive proximate the feed material inlet so as to support the pipe proximate the feed material inlet while allowing the conveyor drive to rotate relative to the pipe; and activating the conveyor drive.

Further steps may include removing and reinstalling the flight without welding.

Further steps may include at least one step selected from among the group of steps including rotationally adjusting the pipe relative to the housing portion, removing the pipe from the housing portion, and reinstalling the pipe in the housing portion, these steps being performed without welding.

The steps of the method may be conducted in a plurality of instances in a plurality of the housing portions, the feed material inlet of the second and subsequent of the plurality of housing portions receiving feed material from the feed material outlet of the previous one of the plurality of housing portions. Respective conveyor drives in the plurality of instances are operable at independently controlled rates of rotation.

The method may include arraying within the housing portion a closely approximated plurality of the pipes and helical flights so interrelated so that any two helical flights which are mutually adjacent are also opposite-handed; operatively coupling the plurality of pipes and helical shafts to a common conveyor drive; and

with the common conveyor drive, rotating the plurality of flights in a manner ensuring that any two flights which are mutually adjacent are also counterrotating at a common speed. A plurality of housing portions may be so employed while interconnected, inlet-to-outlet, serially. They may be operated at independently controllable speeds.

The method may include a step of withdrawing a fluid from the pipe through a purge tube disposed therein.

The method may include a step of supplying a fluid to the pipe through a fluid circulation tube disposed therein.

The present invention provides the large surface area in a small volume. Use of these methods and apparatus provide utility by allowing a waste heat stream to supply the energy typically required to dry materials. Utility for a fuel driven system is a consequence of its efficient heat transfer. An exemplary embodiment of the heat exchanger in accordance with the present invention provides apparatus for economically continuously thermally processing a solid using an organic vapor or steam (or other thermal fluid such as, for example, a molten salt) as a heating medium for a heat exchange surfaces of a plurality of fixed pipes without any need for rotary unions. A rotating spiral (also referred to herein as a flight or as an auger flight) on the outside of the pipe conveys the process material longitudinally over the surface of each heat exchange pipe. The pipes are of smaller diameter than is typical of shafted thermal screws, allowing the spiral conveyors outside the pipes to operate at a higher rate of rotation while maintaining the same peripheral speed (peripheral speed is the speed of the inner portion of the spiral as it rides on the pipe, not the speed of the outer portion of the spiral), resulting in improved mixing and, consequently, an improved U factor without undue wear.

Also in accordance with the present invention, the heat exchange pipes are easily rotated after they have become worn on one side, so that all four sides can be utilized before the pipes must be replaced. This rotation is accomplished by merely unbolting flanges that hold the pipes in place and turning the pipes.

Also in accordance with the present invention, it is feasible to process solids that would at least sometimes foul the heat exchanger surfaces or stick to the mechanical surfaces that are conveying the material through the heat exchanger. The exchanger in accordance with the present invention can be operated to continuously or intermittently scrape the heat exchanger surfaces and the mechanical conveyor surfaces.

Also in accordance with the present invention, such scraping may be accomplished without metal-to-metal contact between scrapers when surfaces passing in mutual close proximity dislodge the adhered or adhering material. Sometimes, as in the case of the conveyance surfaces, it is sufficient to only remove a portion of the adhered material in order to maintain the void to be occupied by moving material. Sometimes, a thin fouling layer remaining on a surface is tolerable after most of the material has been dislodged. Advantageously, minimizing metal-to-metal contact reduces wear on the heat exchanger.

The material being processed frequently undergoes considerable shrinkage in volume. Advantageously, the exchanger in accordance with the present invention uses multiple heat exchangers arranged in sequence, such that the speed of movement through each heat exchanger can be controlled independently. Thus, as process material shrinks, it can be conveyed more slowly when it enters a exchanger segment which is set at a lower speed. This makes it possible to maintain the level of process material to assure complete cover and contact with the entire heat exchange surface in each segment of the heat exchanger.

The U factor is improved by higher rotational speed of the spirals (radians per second), resulting in a peripheral speed of at least up to 26 feet per minute. However, many of the materials to be processed are at least somewhat abrasive. Wear on metal parts is understood to be a function of the square of the speed of the movement. In somewhat abrasive duty the wear on screws limits the speed at which they can be rotated with acceptable life to about 19 feet per minute peripheral. This is 2 rpm for 3 inch diameter screws. Because the U factor is improved by higher speed, it is desirable to limit the diameter at which the friction between the pipe and the spiral that rides on it takes place while using more rotational speed to maximize the mixing. The peripheral speed, again, is the speed of the inner portion of the spiral as it rides on the pipe, not the speed of the outer portion of the spiral. Thus, at a given rate of rotation, if the pipe diameter is reduced, this peripheral speed is reduced. Consequently, abrasive wear is reduced.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein

FIG. 1 shows a side elevational view of a first exemplary embodiment of the heat exchanger in accordance with the present invention and includes a cut-away portion providing a partial interior view;

FIG. 2 is a side sectional view of the embodiment of FIG. 1;

FIG. 3 is a perspective view of the embodiment of FIG. 1;

FIG. 4 is a left side elevational view of the embodiment of FIG. 1;

FIG. 5 is a top plan view of the embodiment of FIG. 1;

FIG. 6 is another perspective view as in FIG. 3, in a state of partial disassembly;

FIG. 7 is a detail view of the opened first steam chest in FIG. 6;

FIG. 8 is a detail view of the opened fourth transport system in FIG. 6;

FIG. 9 is a side view of a shaftless helical flight riding on a pipe in accordance with the present invention;

FIG. 10 shows the pipe, the pipe flange and the post;

FIG. 11 shows the flight with a terminal ring formed on its distal end and an auger shaft attached to its proximal end;

FIG. 12 shows a full-length view of a flight with the auger shaft attached;

FIG. 13 shows a full-length view of a plurality of flights intermeshed in pairs of counterrotating opposite-handed flights, with auger shafts attached; and

FIG. 14 shows a partial side sectional view of an exemplary embodiment for heating a feed material while processing it.

FIG. 15 shows another partial side sectional view of the embodiment of FIG. 14.

FIG. 16 shows a partial end sectional view of the embodiment of FIG. 14.

FIG. 17 shows a partial side sectional view of an exemplary embodiment for cooling a feed material while processing it.

FIG. 18 shows another partial side sectional view of the embodiment of FIG. 17.

FIG. 19 shows a partial end sectional view of the embodiment of FIG. 17.

### DETAILED DESCRIPTION OF THE PREFERRED EMBODIMENTS

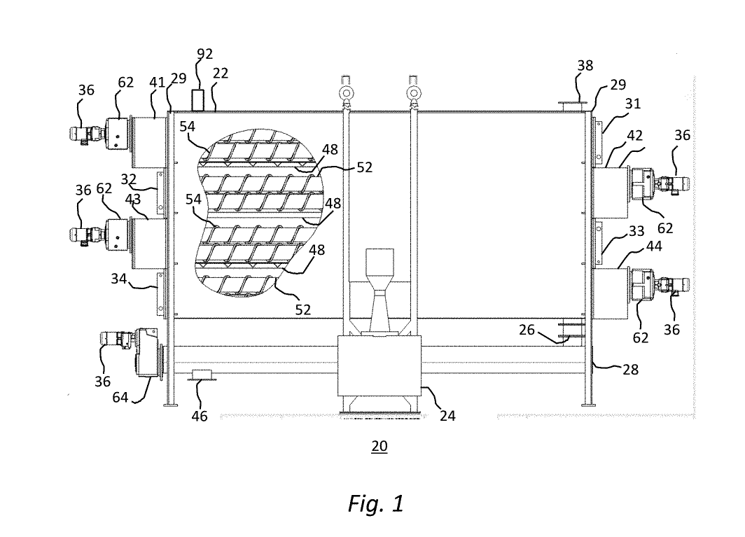

FIG. 1 shows a side elevational view of a first exemplary embodiment of the heat exchanger in accordance with the present invention, shown generally at 20, having a housing 22, first through fourth steam chests 31, 32, 33, and 34, first through fourth transport systems 41, 42, 43, and 44, a condenser 24, an air lock 26, a discharge system 28, motors 36, a feed material inlet 38, a feed material outlet 46, conveyor drives 62 and discharge drive 64. Partially cut away, this view shows trays 48, pipes 52, and transport augers 54 located inside the housing 22.

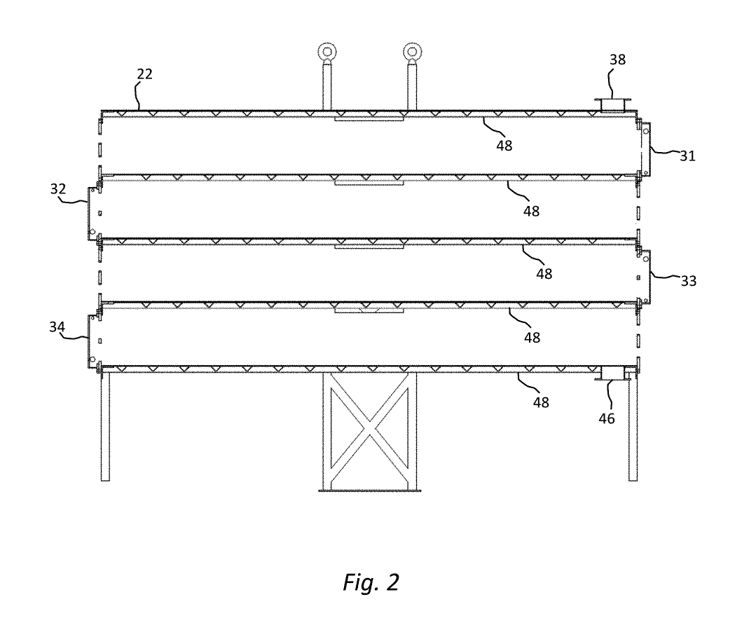

FIG. 2, a side sectional view of the embodiment of FIG. 1, shows the housing 22, first through fourth steam chests 31, 32, 33, and 34, feed material inlet 38, feed material outlet 46, and trays 48.

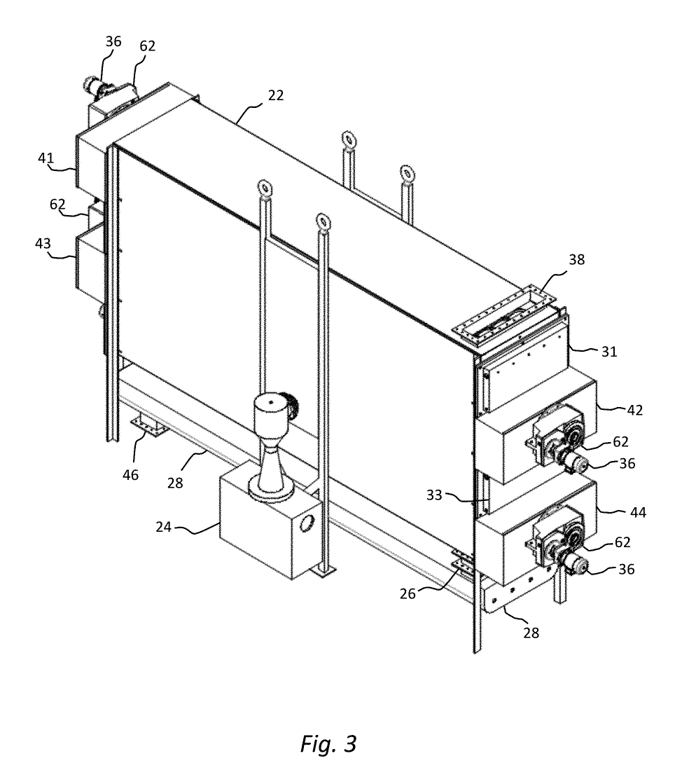

FIG. 3, a perspective view of the embodiment of FIG. 1, shows the housing 22, first and third steam chests 31 and 33, first through fourth transport systems 41, 42, 43, and 44, a condenser 24, an air lock 26, a discharge system 28, motors 36, a feed material inlet 38, a feed material outlet 46, and conveyor drives 62.

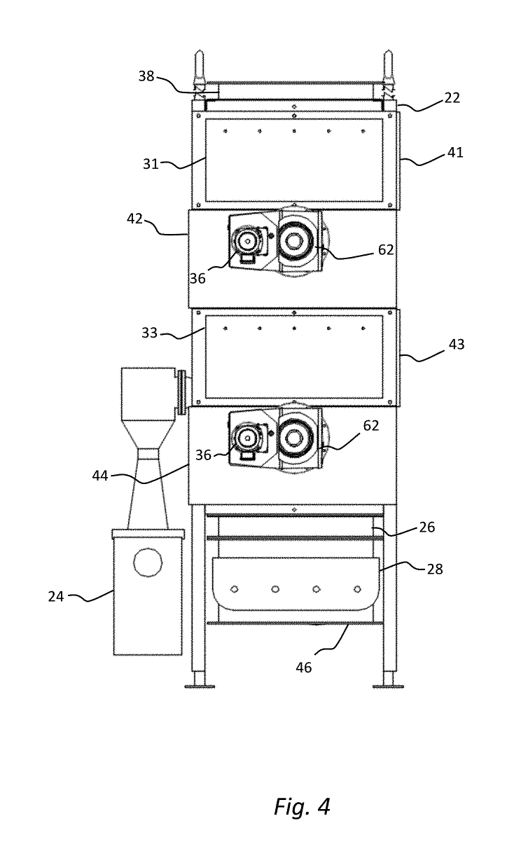

FIG. 4, a left side elevational view of the embodiment of FIG. 1, shows a housing 22, first and third steam chests 31 and 33, first through fourth transport systems 41, 42, 43, and 44, a condenser 24, an air lock 26, a discharge system 28, motors 36, a feed material inlet 38, a feed material outlet 46, and conveyor drives 62.

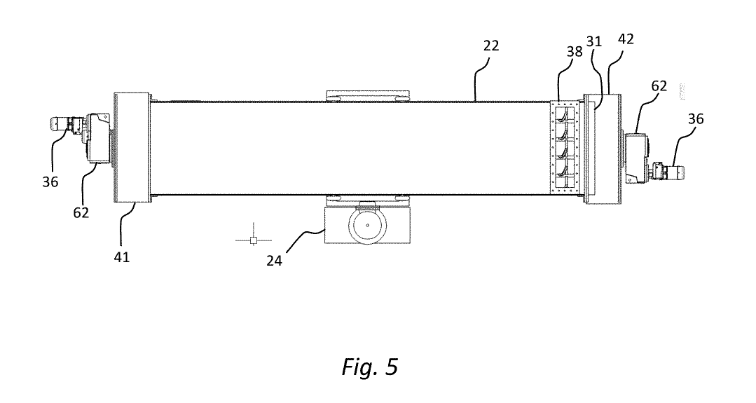

FIG. 5, a top plan view of the embodiment of FIG. 1, shows a housing 22, first steam chest 31, first and second transport systems 41 and 42, a condenser 24, motors 36, a feed material inlet 38, and conveyor drives 62.

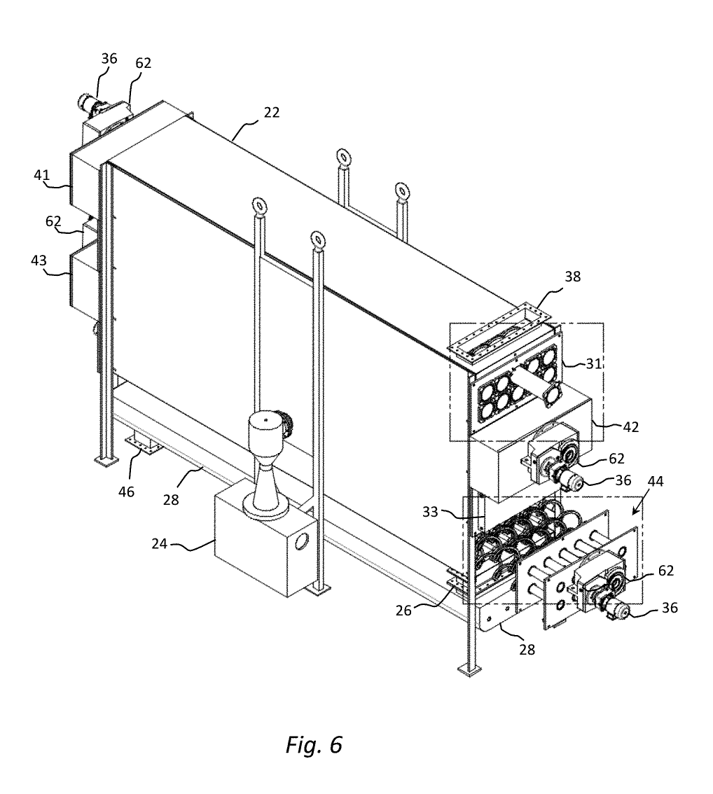

FIG. 6, another perspective view as in FIG. 3, shows the housing 22, first and third steam chests 31 and 33, first through fourth transport systems 41, 42, 43, and 44, a condenser 24, an air lock 26, a discharge system 28, motors 36, a feed material inlet 38, a feed material outlet 46, and conveyor drives 62. The first steam chest 31 is shown in an opened condition, revealing ten pipes 52 in a two-by-five array, one pipe 52 being shown partially withdrawn from the steam chest 31. The fourth transport system 44 is shown in an opened condition, revealing a two-by-five array of ten auger shafts 72 each having attached thereto a shaftless helical flight 74, all extending into the fourth steam chest 34. In FIG. 6, the auger shafts 72 are illustrated for general purposes only, to show their location and their close mutual proximity, without particular attention to their handedness, an important consideration which is discussed elsewhere below.

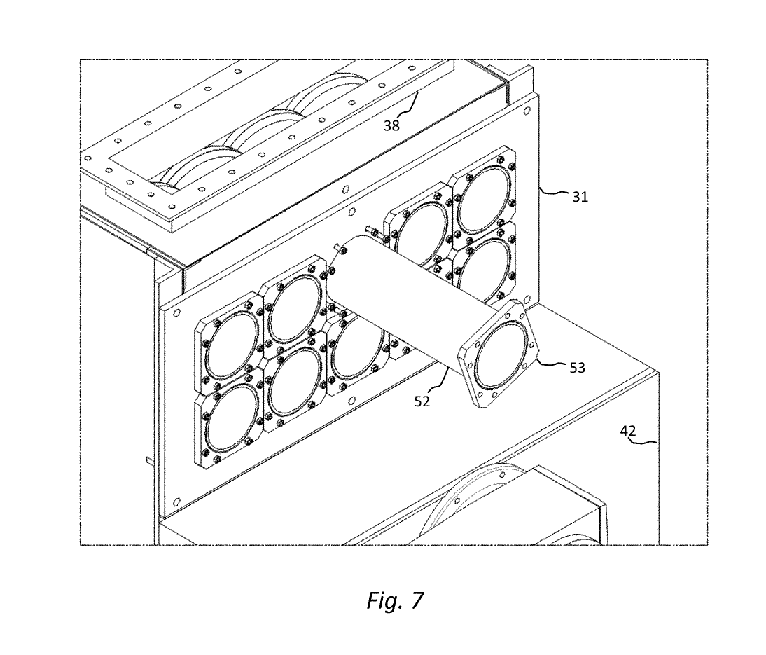

FIG. 7, a detail view of the opened first steam chest 31 in FIG. 6, shows one of the pipes 52 having a flange 53. The flange 53 of the extended one of the pipes 52 has been detached from the first steam chest 31, permitting easy withdrawal and rotation of the pipe 52, which is indeed shown rotated and partially withdrawn. For overall reference, the first steam chest 31 is shown located below the feed material inlet 38 and above the second transport system 42.

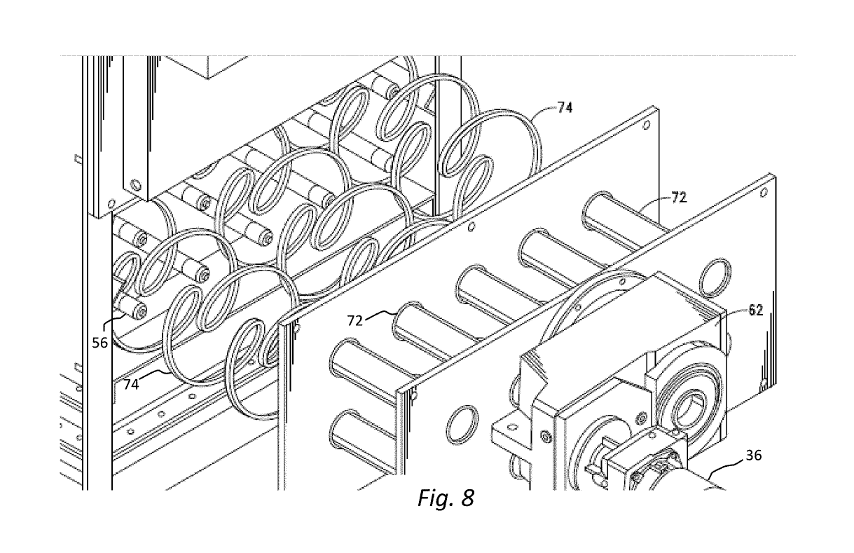

FIG. 8, a detail view of the opened fourth transport system 44 in FIG. 6, shows a moter 36, a conveyor drive 62, and ten auger shafts 72 in a five-column by two-row array. Not quite visible are the pipes (52 in FIG. 1); however, FIG. 8 shows pipe posts 56 (discussed later with reference to FIG. 10). The pipe posts 56 are shown withdrawn from their assembled location. That assembled location would have the pipe posts 56 coaxially engaged with the auger shafts 72 by means of bearings (also not shown in FIG. 8) which allow rotation of the auger shafts 72 relative to the pipe posts 56. In the actual structure of this embodiment of the present invention, each auger shaft 72 has attached to it a shaftless helical flight 74. In FIG. 8, the flights 74 have been partially withdrawn from the fourth steam chest 34 and are still connected to the conveyor drive 62 of the fourth transport system 44. For purposes of simplification, FIG. 8 is drawn with only the first, third and fifth columns of shaftless helical flights 74. A key feature to be noticed in FIG. 8 is the proximity and handedness of the shaftless helical flights 74: adjacent helical flights 74 are intermeshed and oppositely handed. In the embodiment of the present invention, any two helical flights 74 which are adjacent (whether vertically or horizontally) are oppositely handed. In the present invention, oppositely handed helical flights 74 rotate oppositely as well, so that (1) they do not collide and (2) collectively, they all urge the feed material in the same longitudinal direction. Were all ten helical flights 74 drawn, the figure would be crowded and difficult to interpret. In the present invention, closely intermeshed mutually cleaning adjacent flights are oppositely handed and counterrotate. It also should be noted that in the present invention, the term “intermeshed” means that the adjacent helical flights 74 are approximated closely enough that they move through the same space at different times; not that they are tangled with or wrapped around one another.

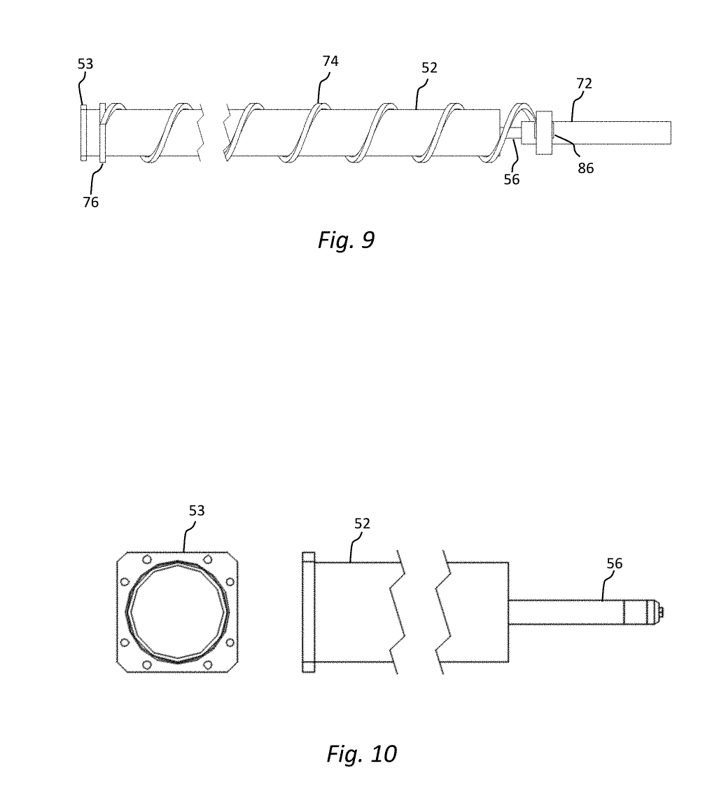

FIG. 9 shows a side view of a shaftless helical flight 74 riding on a pipe 52. The inside diameter of the flight 74 is slightly greater than the outside diameter of the pipe 52. The flight 74 is attached to an auger shaft 72 and to a terminal ring 76. A pipe post 56 extends coaxially from the pipe 52 into the auger shaft 72. A bearing, not shown, allows the auger shaft 72 to rotate relative to the pipe post 56.

FIG. 10 shows the pipe 52, the pipe flange 53 and a post 56. Each post 56 is adapted to be inserted into a corresponding auger shaft 72.

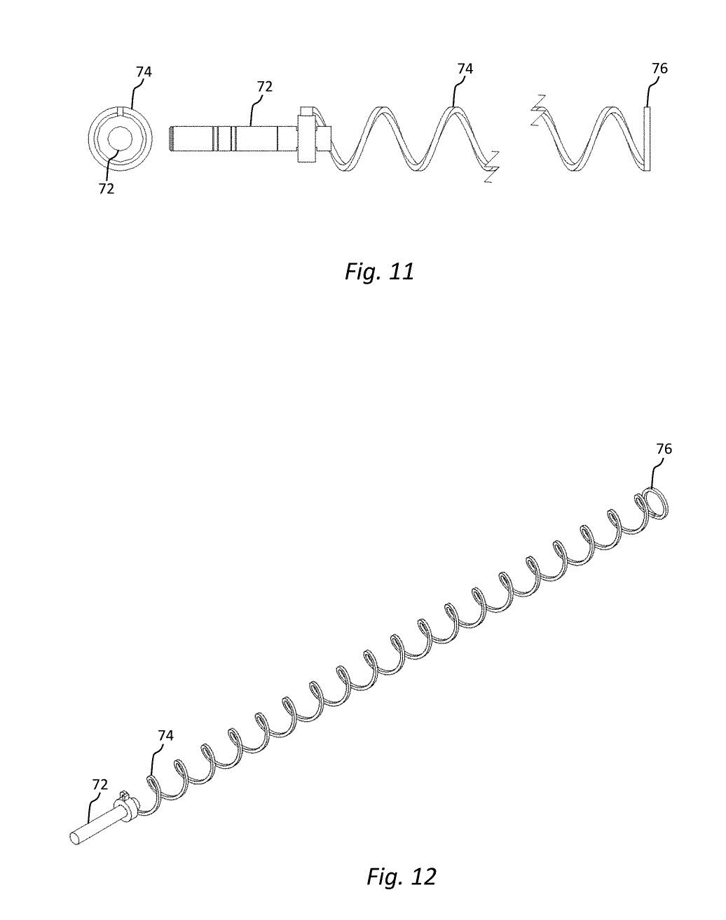

FIG. 11 shows the flight 74 equipped proximally with a terminal ring 76 and distally with an auger shaft 72.

FIG. 12 shows a full-length view of a flight 74 with the auger shaft 72 and terminal ring 76 attached.

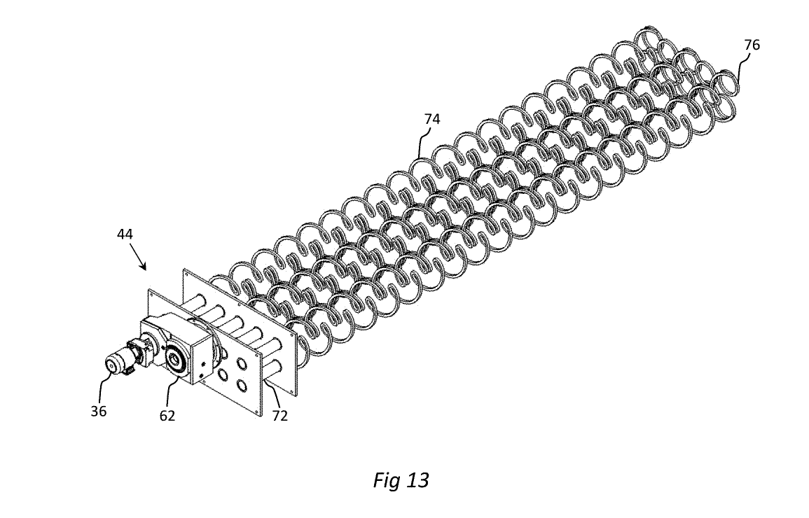

FIG. 13 shows a full-length view of a plurality of flights 74 intermeshed in pairs of counterrotating opposite-handed flights 74, with auger shafts 72 and terminal rings 76 attached. The auger shafts 72 are shown mounted in the fourth transport system 44 having a motor 36 and a conveyor drive 62. An important feature to be noted in FIG. 13 is that adjacent flights 74 are intermeshed and are opposite-handed.

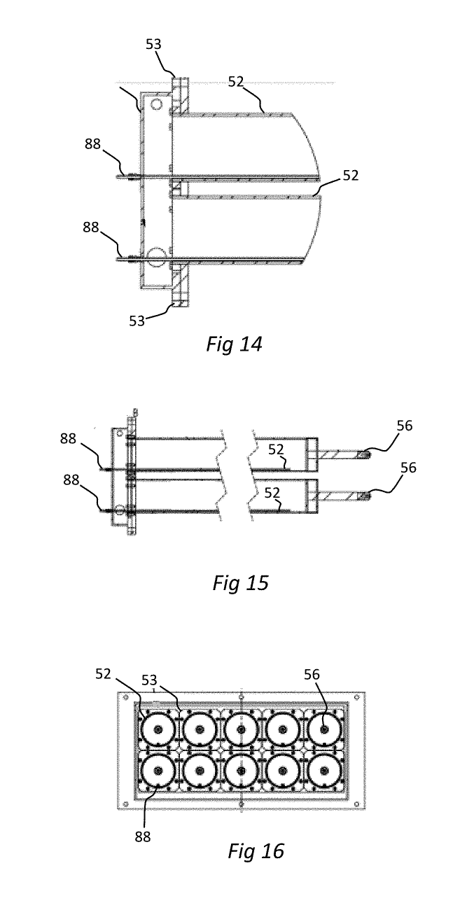

FIG. 14 shows a partial side sectional view of an exemplary embodiment of an exchanger in accordance with the present invention configured for heating a feed material while processing it. A purge tube 88 is positioned low in the pipe 52 and is shown traversing the steam chest 31 and establishing a fluid path between the space inside the pipe 52 (shown with flange 53) and any suitable means for withdrawing fluid from the space inside the pipe 52.

FIG. 15 shows a different partial side sectional view of the embodiment of FIG. 14. The purge tube 88 is shown extending within the pipe 52, most of the way toward the pipe post 56. FIG. 16 shows an end sectional view of the embodiment of FIG. 14, showing a plurality of pipes 52 with flanges 53, pipe posts 56 and purge tubes 88.

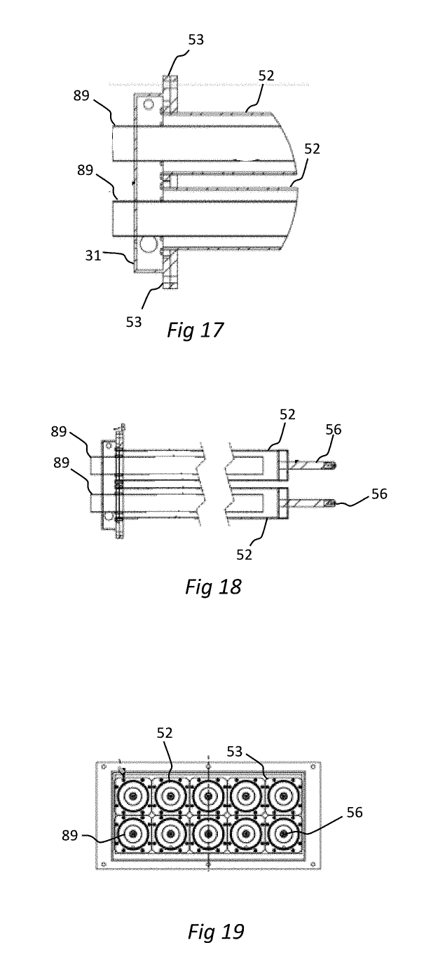

FIG. 17 shows a partial side sectional view of an exemplary embodiment of an exchanger in accordance with the present invention configured for cooling a feed material while processing it. An enlarged fluid injection tube 89 is shown, roughly concentric with the pipe 52, traversing the steam chest 31 and establishing a fluid path between the space inside the pipe 52 (shown with flange 53) and any suitable source of cooling liquid.

FIG. 18 shows a different partial side sectional view of the embodiment of FIG. 17. The fluid circulation tube 89 is shown extending within the pipe 52, most of the way toward the pipe post 56. FIG. 16 shows an end sectional view of the embodiment of FIG. 14, showing a plurality of pipes 52 with flanges 53, pipe posts 56 and purge tubes 88.

FIG. 19 shows an end sectional view of the embodiment of FIG. 17, showing a plurality of pipes 52 with flanges 53, pipe posts 56 and purge tubes 89.

The exemplary embodiment of FIG. 1 shows four transport systems 41-44 arranged in series. In alternative embodiments, the number of transport systems in series may be any number from one to eight. Advantageously, the number of transport systems can be chosen based on overall process parameters and physical constraints.

The housing 22 serves to contain the feed material, allowing the transport systems 41-44 to move the feed material through the transport systems 41-44 in series. The housing 22 provides for flanged mounting of the transport systems 41-44 and steam chests 31-34. The housing 22 also contains the gases which evolve from the feed material and directs these gases to the condenser 24. The housing 22 provides for the feed material inlet 38 and feed material outlet 46, through which the feed material flows. Not shown in the drawing figures is an input hopper from which feed material is supplied to the feed material inlet 38. The feed material outlet 46 is connected to an air lock 26. In some alternative embodiments, an air lock similar to the air lock 26 is located between the input hopper and the feed material inlet 38.

The steam chests 31-34 provide surfaces through which heat is transferable from a heat transfer medium such as steam to the feed material. The steam chests 31-34 provide the inside surface of each pipe 52 for steam (an exemplary heat transfer medium, although by no means the only one contemplated in accordance with the present invention) to condense and release latent heat into the metal of the pipe 52. The steam chests 31-34, support the pipes 52 so that the pipes 52 may deliver heat to the feed material. The steam chests 31-34 provide a path for the condensed steam (a liquid) to drain from the steam pipes 52 so that it may be re-heated. The steam chests 31-34 provide a plenum so that steam can be distributed to a multiplicity of steam pipes 52. The steam chests 31-34 provide a mechanical constraint for the shaftless auger flights 74 in the transport systems 41-44.

Each of the transport systems 41-44 moves the feed material through each module, by means of a plurality of shaftless auger flights 74 each rotated by one or more gear motors, by a multiple stage gearbox, or by a system of gears or chains and sprockets. The auger shafts 72 of each of the transport systems 41-44 ride pipe posts (56 in FIGS. 9 and 10) which are located on a plurality of pipes 52 in the respective steam chests 31-34. Each pipe 52 is supported at both of its ends: a first end 55 and a second end 57. The first end 55 rides a bearing in the center of the end of the auger flight 74 that rides it, that auger flight 74 being itself rotatably supported by the respective one of the steam chests 31-34. The second end 57 of the pipe 52 forms a flange 53 which is supported by the respective one of the steam chests 31-34. Each one of the transport systems 41-44 independently controls the speed of rotation of the flights 74 contained therein. Each of the transport systems 41-44 coordinates the relative angular positions of all flights 74 therein to prevent impingement.

The condenser 24 accepts vapor evolving from the feed material (for instance, evaporated water and other volatile organic components contained in the feed material), and converts at least a portion of such vapors to their liquid phases.

The air lock 26 opens and closes, periodically closing to seal the housing 22 so that the feed material vapors are directed to the condenser 24, periodically opening to allow feed material to drop under the influence of gravity into the discharge system 28.

The discharge system 28 accepts processed feed material from the fourth transport system 44, removes it from the housing 22, transfers the processed feed material to an output area, and, optionally, cools the processed feed material during transport through the discharge system 28.

Importantly, both the steam chests 31-34 and the transport systems 41-44 are removable from the housing 22. Each steam chest 31-34 of the illustrated embodiment contains ten pipes 52 arranged parallel in a two-by-five array extending through it. In alternative embodiments, the number of parallel steam pipes 52 is between one and twenty. Each pipe 52 is removable from the one of the steam chests 31-34 that it occupies. Each pipe 52 is connected to a flange 53, allowing independent removal of each pipe 52 from the steam chest 31-34. Alternatively, an entire steam chest (any one of the steam chests 31-34) can be removed from the housing 22 via a flange connection that couples each of the steam chests 31-34 to the housing 22.

Each transport system 41-44 has ten shaftless auger flights 74, which rotate to move the feed material in the respective transport systems 41-44. The number of auger flights 74 in each transport system 41-44 is the same as the number of pipes 52 in the same transport system 41-44. The fourth transport system 44 is shown partially removed by means of removing the flange connection of the transport system 44 to the housing 22.

The housing 22 has five vertically spaced trays 48 mounted between two side panels 23, the trays and side panels 23 forming channels through which the feed material moves and through which the vapors evolving from the feed material flow. Reinforcement of the side panels 23 is done in a manner typical of sheet metal strengthening. Not all of the process material will move concurrently; a small portion may be left behind. Such remnant material will not affect the heat transfer of the pipes 52 and it may or may not remain permanently channeled between the side panels 23 and the trays 48.

Each tray 48 has a single hole on its drive end (the end where a drive is mounted) of the spiral through which the feed material discharges by gravity. Each tray 48 is flipped relative to the tray 48 above, such that the input to the tray 48 (from the top) and the output of the tray 48 (from the bottom) are on opposite ends. This, in combination with alternating the direction of the steam chests 31-34 and transfer systems 41-44, causes the feed material to reverse direction as it passes from one tray 48 to the next. An even number of trays 48 causes the process material to enter and exit on the same side of the apparatus; an odd number, on the opposite side.

For each tray 48, the feed material enters on the same side (end) as the steam chest (one of 31-34) occupying that tray 48. For each tray 48, the material is moved by auger flights 74 which are driven by a single gear motor or multiple gear motors per tray. Advantageously, the motor speed for each tray may be uniquely chosen to optimize the process material transfer rate, which is measured in cubic feet per minute. Thus, e.g., shrinkage of feed material resulting from drying can be accommodated.

The housing 22 has four flanges 29 (see FIG. 1 for approximate location) on each end, each flange 29 being used to mount a single steam chest (one of 31-34) and a single transfer system (one of 41-44). When assembled, these flanges 29 support the trays 48 and side panels 23 to sealingly channel the feed material.

A plenum is in communication with each of the four channels that are established by the trays 48 and side panels 23, through holes in the side panel (not shown, behind the plenum), where the process vapors combine and become available to the condenser through a common port.

Access to the interior of the housing 22 may be provided by access panels (not shown), for use in cleaning, assembly and disassembly.

FIG. 9 describes a single pipe 52 and the flight 74 that rides on the pipe 52. The pipe 52 is positioned approximately concentrically within the flight 74, the flight 74 ID being slightly larger than the steam pipe 52 OD. The flight 74 OD is chosen, in combination with the spacing between steam pipes 52, to allow overlap of the auger flights 74. In a preferred embodiment, the spacing between pipes 52 is 10.5 inches, the flight 74 ID is 9 inches, the flight 74 OD is 11 inches, and the steam pipe 52 is OD 8.625 inches. Also shown is a pipe post 56 which is endwise rotatably coupled to the auger shaft 72 that holds and drives the flight 74.

The flight 74 pitch, which determines how quickly the feed material moves through the housing 22 at a given motor speed, is 12.5 inches.

Many other geometries are similarly possible, and the choice of this geometry is based on the particular application. The auger flight 74 may be raw metal, or coated metal, with for instance teflon used as a friction reducer between the flight 74 and the steam pipe 52.

The pipe 52 is mounted, sealed and supported on its input end (second end 57) by a pipe flange 53, and may be removed independently of the other steam pipes 52. The pipe 52 is supported on its far end (first end 55) by a short rigid pipe post 56 which slides into a concentric hole machined into the corresponding one of the auger drive shafts 72. The short rigid pipe post 56 is stationary, while the auger shaft 72 rotates. Bearing surfaces are provided on both the OD of short rigid pipe post 56 and the ID of the hole in the auger drive shaft 72.

The auger shaft 72 is rotated by one or more gear motors and gearing, using a single motor for each transport system 41-44, through intermeshed gearing. Intermeshed gearing (not shown) results in adjacent auger shafts 72 rotating in opposite directions. The flights 74 coupled to the respective auger shafts 72 also alternate in their handedness. Thus, all flights 74 in a given array of flights 74 urge the feed material in the same longitudinal direction.

The flight 74 is attached to the auger shaft 72 by means of an auger clamp 86. The relative angular orientation of each flight 74 versus its auger shaft 72 is determined by the rotational angle of its connection to the auger clamp 86. In one exemplary embodiment, radial holes are machined into the auger clamp 86 at the desired orientation for attachment. In another embodiment, the shaft 72 may be machined to accept a common clamp 86 at the desired orientations.

As a matter of convenience, use of a split-clamp-type auger clamp 86 between the shaft and flight allows each auger flight 74 to be removed independently, once the entire transfer system (one of 41-44) is removed from the housing 22.

In a preferred embodiment, the relative angular alignment is zero for all augers, resulting in minimum overlap between auger flights 74. In another embodiment, the angular alignment is set for the maximum possible overlap (the auger flights 74 must not interfere with each other), and is determined by the formula: (360 degrees)/(number of augers), in this described case 36 degrees. This configuration additionally self-cleans the surfaces of the flights 74.

FIG. 5 shows the steam chest (one of 31-34) and pipe 52. Each steam chest 31-34 comprises a plurality of steam pipes 52 (in this case ten equally spaced on 10.5 inch centers, in an array). The steam chest 31-34 has a steam plenum which serves as both the input for steam (the heat source), and an output for the condensed water.

The steam enters the steam plenum through a single port, and fills the plenum and the steam pipes 52. The steam condenses onto the interior surfaces of the pipes 52, which are being cooled by the process material on the outer surfaces of the pipes 52. The steam releases its latent heat to the pipes 52 by condensing to the liquid phase. The liquid drains by gravity to the bottom of the pipe 52, and then into the steam plenum. The housing 22 should be leveled for proper condensate removal. The condensate accumulates in a sump tank (not shown) and is periodically pumped out of the system.

At startup, and to a lesser degree during operation, non-condensable gases can be present and accumulate in the steam pipes 52, most probably towards the far end (first end 55) of the pipe 52. These non-condensible gases will block the heat transfer surfaces inside the pipe 52. A purge tube (88 in FIGS. 14-16), one for each steam pipe 52, allows the pipe 52 to be both evacuated (for instance at start up), and purged (for instance periodically during operation). The purge tubes 88 extend through and past the steam plenum, and thus the entire steam chest 31-34 and plenum are evacuated and purged in common.

Description has referenced steam as a heat transfer medium. Other heat transfer media include, e.g., waste steam from an upstream process, steam produced by a boiler or vaporizer, vaporized thermal oil produced by a boiler or vaporizer, and molten salt.

Not all applications are for heating a feed material. An exemplary embodiment cools a process material to approximately the vaporization temperature of a liquid. Alternatively, a process material is transfered while maintaining a stable temperature, with little heat transfer, at the vaporization temperature. In such an embodiment, shown more particularly by FIGS. 14-16, the steam plenum output port is sealed and the purge tubes 88 are utilized to introduce the liquid (for instance, cold water) into the pipes 52. The outsides of the pipes 52 are heated by the feed material, which heats the liquid inside the pipes 52. The liquid reaches its vapor temperature and evaporates. The vapors exit the pipes 52, flowing through the steam plenum and exit the steam plenum input port. In this example, heat is removed from the process material through the vaporization of a liquid. A closed liquid cycle can be accomplished by utilizing standard methods.

Alternatively, as is well known in the industry, a cool liquid can be circulated to cool the solid.

FIGS. 17-19 describe an exemplary embodiment in which the heat transfer fluid is maintained as a liquid. The size of the fluid circulation tube 89 is increased, such that the cross-section areas of the tube and the resulting annulus in the pipe 52 are similar. The fluid circulation tube 89 is placed concentric to the pipe 52. A support may be added at intervals down the length of the fluid circulation tube 89. The steam plenum output port is sealed. In this example, liquid enters the purge tubes 89, flows backwards through the annulus between the fluid circulation tube 89 and the pipe 52, through the plenum, and out the plenum input port. As the liquid flows through the annulus, it heats (or cools) the process material by conduction and convection at the walls of steam pipes 52. A closed liquid cycle can be accomplished by utilizing standard methods. Applicable heat transfer fluids include water, thermal oils, and molten salts.

In acordance with the present invention, a solids heat exchanger has a large heat exchange surface area formed by non-rotating long pipes 52 commonly connected on one end to the vapor supply or condensate return chamber without any need for rotary unions. Similarly, a liquid thermal fluid supply and return can be connected without any need for rotary unions. The ratio of length to diameter for the pipe 52 is up to 30 to 1. Shaftless rotating helical flights 74, which also function as scrapers, encircle each pipe 52 and convey the material in the process chamber from the feed end to the discharge end. All of the flights 74 are intermeshed, with each flight 74 a predetermined close clearance from each of the intermeshed adjacent flights 74. This arrangement of adjacent flights 74 scrapes the sides of all of the flights 74 to prevent the potential build up of adhered material that would eventually impair the conveying efficiency of the flights 74. The minimum number of pipes 52 and spiral flights 74 is four if the material to be processed adheres to the conveying surfaces. If it only fouls the heated surfaces, it is not necessary to have at least four, because it is not necessary for the flights 74 mutually to clean one another. When self cleaning is required, there must be at least four flights 74 intermeshed.

The solids heat exchanger has an enclosed process chamber with an inlet 38 for the feedstock high on the process chamber near the feed end. The process chamber also has an outlet 46 on the bottom for the processed material near the outlet end. The double-walled housing 22 enclosing the process chamber optionally can be heated also. A vapor outlet 92, a vent, is fitted to the top of the enclosed process chamber to remove the vapors released from the process material.

In an exemplary embodiment, multiple heat exchangers may be stacked one above another in a single process chamber with the feed ends alternating with the discharge ends of multiple heat exchangers thus passing the partially processed material from the discharge of one unit to the feed of the next lower unit. The material moves in a continuous downward zigzag pattern from one heat exchange unit to the next, finally discharging from the bottom of the process chamber after the completion of the process at the discharge end of the bottom heat exchanger.

The heat exchanger surfaces and communicating heating medium/condensate return chamber can be a pressure vessel assembly mounted through and enclosing the feed end of the process chamber and extending substantially through the entire length of the process chamber. Fixed stub shafts in each extending heat exchange surface support the distant ends of the heat exchange surfaces. As can be appreciated, alternatively, a fixed bearing can be fitted to receive an extending pipe post 56.

The heat exchanger includes a vertical vapor supply/condensate return chamber with horizontal pipes extending singly or in an array. The heat exchange surfaces are the pipes and, inconsequentially, the surface of the end of the chamber. No pressure containing surface shape is less expensive than a cylinder formed as a pipe. The use of this material for construction allows for more area to be used to accomplish the required capacity at the same cost. For example, the only fabrication required on the pipes 52 is enclosing the pipes 52 in the heat exchanger, welding the full pipe-diameter mounting flange 53 onto the communication end of the pipe 52, and, on the other end of the pipe 52, welding in the plug fitted with the supporting pipe post 56.

The vapor supply/condensate return chamber supports one end of the pipes 52 and is the connection between the vapor supply and each pipe 52. It likewise connects the bottom of the pipes 52 with the condensate drain on the bottom of the chamber. The outer side of the vapor chamber is optionally fitted with a port for multiple small vent tubes (purge tubes 88) for venting of air during startup as discussed in the process section.

In one embodiment, the vapor chamber is constructed of two parallel thick plates which can be flanges 29 (see FIG. 1).The back plate is removable for service access. The inner plate is bored as a tube sheet with non-through holes threaded from the inside face to receive studs that compress the gasket that seals the flanged pipes 52 through the tube sheet. The flanges are square sided and can be rotated as the topside of the pipe 52 wears. The pipe 52 can be rotated to use each side thereby extending the useful life of the heat exchange surfaces. The removable back plate of the heat exchanger allows access to rotate or replace the pipes 52. The entire assembly, a vessel appropriate for containment of the pressure of the supplied heating medium, is bolted and sealed to the process chamber enclosure.

The first-in/first-out functions of conveying the material, mixing the material, preventing material from adhering to the conveying surfaces that could eventually plug the heat exchanger and maintaining the heat exchange efficiency by scraping the fouling material from the pipes 52 is accomplished by rotating spiral flights 74 in a novel arrangement on the outside of the heat exchange pipes 52.

The arrayed pipes 52 are each scraped by a shaftless auger flight 74 which may also be regarded as a spiral scraper. The spiral flights 74 all have the same pitch but adjacent spiral flights 74 have opposite handedness (handedness is the direction of longitudinal advancement for a given direction of rotation). The drive for the spiral flights 74 is on the discharge end of the heat exchanger or pulling with respect to the longitudinal movement of the material toward the drive/discharge end of the heat exchanger. All spiral flights 74 are arranged one relative to another as two overlapping adjacent spiral flights 74. The two adjacent spiral flights 74 are opposite hand rotation and counter rotating with respect to one another. This allows all the adjacent flights 74 to intermesh in close proximity without hard impingement.

Each spiral flight 74 is clocked with respect to the rotations of the adjacent spiral flights 74, maintaining the same speed of rotation in opposite directions of all of the intermeshed adjacent spiral flights 74. Thus each spiral flight 74 will be maintained in the same fixed rotational position relative to the other spiral flights 74 it is intermeshed with, and the clearance between the spiral flights 74 will remain fixed regardless of direction of rotation. This arrangement of spiral flights 74 is driven in counterrotation at a common speed and in a fixed rotational position with respect to each other maintaining a common narrow clearance between intermeshed spiral flights 74 by a set of gears in the gearbox. An auger drive shaft 72 extends out of the gearbox on center of each spiral flight 74. A bearing in the center of each hollow cantilevered drive shaft 72 supports the stub rigid pipe post 56 that supports the weight of the end of each pipe by the stub rigid pipe post 56. A clamp (86 in FIG. 9) connects the spiral flight 74 to the drive shaft 72. Alternatively a set of sprockets and chains can be used with two gear boxes to drive and position the spiral flights 74.

The gearbox is fitted with a flange that encloses the process chamber at the discharge end of that heat exchanger. As is stated elsewhere in the preferred embodiment a series of heat exchangers are stacked in a reverse flow zigzag pattern with the discharge end on one heat exchanger over the feed of the next lower heat exchanger in a common process chamber.

When it becomes necessary to replace the spiral flights 74 because of wear, the apparatus in accordance with the present invention allows use of a simplified procedure which is superior to that used with normal screws: with the present invention, one simply removes the process-chamber-enclosing gearbox, quickly and economically withdraws the worn spirals, and installs new multiple spirals without any cutting or welding of metal.

As will be explained in the process section, on startup the heating medium chamber contains air which must be removed at startup.

Process:

Step 1: In accordance with the present invention, the heat exchanger, fluidly connected to the heating medium source and the condensate drain, is provided with a large surface area for contact between the heating medium and the material to be processed. There is an inlet 38 and an outlet 46 for the process feed material at distant ends of a traverse through the process chamber on the surfaces of the heat exchangers. Vapor outlets are provided for vapors generated during the process.

Step 2: The process material is continuously feed into the top feed end of the heat exchanger at a speed which causes it to completely cover the heat exchange surfaces.

Step 3: The spiral flights 74 move the material axially on the heat exchange pipes 52. For any given feed rate the adjustable longitudinal speed of the materials determines the residence time in each heat exchanger. If all heat exchangers are covered and the product is correctly processed, a change in feedstock condition can be noticed and used as a basis for changing the feed rate and, thus, the residence times in all heat exchangers (this is done by making proportional changes in the speed of the spiral flights 74).

Step 4: The required residence time for a particular feedstock determines the capacity of the processor. Maximizing the mixing, which increases the U factor, can reduce the required residence time and increase the capacity by allowing a faster feed rate at a shorter residence time and the same fill level. The mixing is accomplished by the counter rotating spiral flights 74 (also called “screws”) displacing the material that was against the hot metal surfaces during a rotation into colder materials that were in the mass of feed material and replacing the previously heated materials with some cooler material from the middle of the mass.

The speed of the spiral flights 74 can be independent of the residence time by use of a forward/reversing motion of the spiral flights 74, which increases mixing by adding an interval of reverse motion of less time than the forward motion. This can allow significantly higher spiral speed while holding the same residence time. The intervals of forward motion can be as short as 45 degrees with the reverse motion as short as 15 degrees with the speed of the spiral flights 74 increased by ⅔ over the continuous forward speed to accomplish the same residence time.

Step 5: A further increase in spiral speed can increase the processor capacity by shortening the residence time by the proportional increase in U factor as a result of the increased mixing.

The Heat Exchange Process:

The generic equation for heat exchangers is Q=A×U×LMDT. For any particular processor; Q, the quantity of energy necessary to accomplish the process that must be heat exchanged is: Q=A, the necessary area of the heat exchange surface×U, the unique heat exchange coefficient of the energy transferred per hour for that heat exchanger operated in a particular manor and unaffected by the temperature of the heating medium *LMDT, the log mean difference in temperature between the temperature of the heat exchange medium and the material being processed.

The effective utilization of A, the area of the heat exchange surface in the apparatus is accomplished in the invention by the use of multiple heat exchangers in the same processor. For example, with four heat exchangers in a processor of 1800 square feet, the conveyance speed of each heat exchanger can be individually adjusted to maintain the fill level to ensure the heat exchange surfaces are covered regardless of the amount of shrink in the processed material.

The apparatus of the invention optimizes the U of the processor by the use of many smaller diameter heat exchange pipes 52 per heat exchanger. An example with a higher U factor has 10 pipes of 8 inch diameter in each of the four heat exchangers, with rotating spiral flights 74 of small height, with 13″ outside diameters, and faster rotating spiral flights 74; for example, 7 rpm, with frequent reversing motions; for example, 20 degrees reverse and 45 degrees forward. The counter rotating intermeshed spiral flights 74 mix the surrounding materials in both directions of rotation with a mixing motion resembling the action of an eggbeater.

As water evaporates from the material in the processor, the vaporous heating medium condenses on the inside of the heat exchanger pipe 52. The reduced pressure in the pipes from the condensing vapor allows more vapor into the area of the heat exchange surface.

The temperature of the heating medium is essentially uniform over the whole heat exchange area as all pipes 52 are connected at the same vapor pressure. The major resistance to heat exchange is in the material contact with the outside of the pipes 52. The heat exchange is improved by mixing of the heated material into other cooler materials.

The condensate runs to the bottom of the pipes 52 that have full diameter connections to the vapor chamber allowing the condensate to flow by gravity out of the pipes 52 into the vapor/condensate chamber. The returning condensate drains from the bottom connection of the vapor/condensate chamber to the condensate return pump.

The startup of the heat exchangers requires a method of removing the air from the pipes 52 of the heat exchanger. Without a method of removing the air that is in the ends of the pipes 52 the heating vapors cannot flow to the heat exchange surfaces near the ends of the pipes 52 and that surface is lost to the heat exchanger. One method is to fill the entire heating medium space for startup with cool liquid organic heat exchange fluid and then displace the liquid with the hot vapor, pushing the liquid out the condensate drain. This requires an inventory of thermal fluids significantly larger than what is required for operation. Another method is to provide in the apparatus small diameter tubes in each heat exchange pipe 52 for air vents with open ends near the far ends of the pipes 52. On startup, the vents can be opened soon after the vapor pressurizes the tubes. Each vent tube is manually valved which can be used for venting at startup and also for occasional venting of any accumulated air from the end of the pipes. The vents can optionally be vented through a heat exchanger to condense any organic vapor vented for collection and reuse. Another way of venting the air is to deliver the heating medium to the far end of the tubes through a small diameter supply pipe in each heat exchange pipe 52. The vapor then flushes the air out through a provided vent valve on the top of the condensate drain.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

1. An indirect heat exchanging continuous material processor comprising:
a housing portion having a feed material receiving end and a feed material delivering end;
a steam plenum disposed at said feed material delivering end of said housing portion;
a pipe disposed in said housing portion, said pipe having a flanged end supported at and fluidly communicating with and sealingly and removably attached to said steam plenum, said pipe also having a fluidly closed, post-equipped end opposite said flanged end;
a transport disposed at and removably attached to said feed material receiving end of said housing portion;
an auger shaft coupled to and rotationally driveable by said transport, projecting into said housing portion proximate said pipe, rotatably engaging said post-equipped end of said pipe, and supporting said post-equipped end of said pipe;
a helical flight disposed in said housing and riding on said pipe, said helical flight having a proximal end rotationally coupled to and driveable by said auger shaft.

2. The processor of claim 1, said flight being capable of removal and reinstallation without welding.

3. The processor of claim 1, said pipe being capable of rotational adjustment relative to said steam plenum, removal from said steam plenum, and reinstallation in said steam plenum, without welding.

4. The processor of claim 1, said steam plenum being capable of removal from and reinstallation onto said housing portion without welding.

5. The processor of claim 1, comprising a plurality of said housing portions so equipped, said feed material receiving end of the second and subsequent of said plurality of housing portions receiving feed material from said feed material delivering end of the previous one of said plurality of housing portions.

6. The processor of claim 5, respective transports of said plurality of housing portions being operable at independently controllable rates of rotation.

7. The processor of claim 1, said housing portion comprising a plurality of said pipes, auger shafts and helical flights so interrelated,
said plurality of pipes, shafts and helical flights being arrayed such that any two helical flights which are mutually adjacent are also opposite-handed,
said transport driving said plurality of auger shafts in a manner ensuring that any two auger shafts which are mutually adjacent are also counterrotating at a common speed.

8. The processor of claim 5, said housing portion comprising a plurality of said pipes, auger shafts and helical flights so interrelated,
said plurality of pipes, shafts and helical flights being arrayed such that any two helical flights which are mutually adjacent are also opposite-handed,
said transport driving said plurality of auger shafts in a manner ensuring that any two auger shafts which are mutually adjacent are also counterrotating at a common speed.

9. The processor of claim 1, wherein a purge tube is disposed in said pipe and has a first opening within said pipe and a second opening configured for withdrawal of a fluid from said pipe.

10. The processor of claim 1, wherein a fluid circulation tube is disposed in said pipe and has a first opening within said pipe and a second opening configured for supply of a fluid to said pipe via said fluid circulation tube.

11. A method of indirect heat exchanging continuous processing of a feed material, the method including the steps of:
providing a processor housing portion having a feed material inlet and a feed material outlet;
introducing a feed material into said feed material inlet;
contacting said feed material with a helical flight within said housing portion,
supporting said helical flight proximate said feed material inlet and engaging said helical flight with a conveyor drive proximate said feed material inlet;
supporting said helical flight on a pipe disposed within and roughly coaxial with said helical flight;
supporting said pipe proximate said feed material outlet;
supplying a heat exchange fluid to said pipe at a portion thereof proximate said feed material outlet and withdrawing said heat exchange fluid from said pipe proximate said feed material outlet;
operatively coupling said pipe to said conveyor drive proximate said feed material inlet so as to support said pipe proximate said feed material inlet while allowing said conveyor drive to rotate relative to said pipe; and
activating said conveyor drive.

12. The method of claim 11, including steps of removing and reinstalling said flight without welding.

13. The method of claim 11, including at least one step selected from among the (Markush) group of steps including:
rotationally adjusting said pipe relative to said housing portion,
removing said pipe from said housing portion, and
reinstalling said pipe in said housing portion,
said step being performed without welding.

14. The method of claim 11, wherein said steps are conducted in a plurality of instances in a plurality of said housing portions, said feed material inlet of the second and subsequent of said plurality of housing portions receiving feed material from said feed material outlet of the previous one of said plurality of housing portions.

15. The method of claim 14, including steps of operating respective conveyor drives in said plurality of instances at independently controlled rates of rotation.

16. The method of claim 11, including steps of:
arraying within said housing portion a closely approximated plurality of said pipes and helical flights so interrelated so that any two helical flights which are mutually adjacent are also opposite-handed;
operatively coupling said plurality of pipes and helical shafts to a common conveyor drive; and
with said common conveyor drive, roatating said plurality of flights in a manner ensuring that any two flights which are mutually adjacent are also counterrotating at a common speed.

17. The method of claim 14, including steps of:
arraying within said housing portion a closely approximated plurality of said pipes and helical flights so interrelated so that any two helical flights which are mutually adjacent are also opposite-handed;
operatively coupling said plurality of pipes and helical shafts to a common conveyor drive; and
with said common conveyor drive, roatating said plurality of flights in a manner ensuring that any two flights which are mutually adjacent are also counterrotating at a common speed.

18. The method of claim 11, including a step of withdrawing a fluid from said pipe through a purge tube disposed therein.

19. The method of claim 11, including a step of supplying a fluid to said pipe through a fluid circulation tube disposed therein.
